(19) United States
(12) Patent Application Publication
(10) Pub. No.: US 2004/0004763 A1
(43) Pub. Date: Jan. 8, 2004

(54) Electronic virtual lens for observing 3-D or 4-D images

(76) Inventor: Reuben Hoppenstein, New Rochelle, NY (US)

Correspondence Address: Keith D. Nowak, DICKSTEIN SHAPIRO MORIN & OSHINSKY LLP, 41st Floor, 1177 Avenue of the Americas, New York, NY, 10036-2714, US

(21) Appl. No.: 10/410,165

(22) Filed: Apr. 10, 2003

Related U.S. Application Data
(62) Division of application No. 09/772,008, filed on Jan. 29, 2001, now abandoned.

(51) Int. Cl. G02B 27/22

(52) U.S. Cl. 359/466

(57) ABSTRACT

The present invention provides a novel means and technique for viewing stereoscopic images with an electronically-controlled optical grid of thin light transmitting slits which forms a virtual lens.

### FIELD OF THE INVENTION

This invention generally relates to stereoscopic images and specifically concerns novel techniques and apparatus for viewing such images for use with televisions, computer displays, fluoroscopes and other imaging electronic recording and imaging devices, either analog or digital, providing an illusion of depth to the viewer.

### DESCRIPTION OF THE PRIOR ART

Many of the modern day techniques use lenticulated images to create stereoscopic images. These techniques are limited in that they require the use of a lenticular viewing lens to visualize the stereoscopic image. In general, stereoscopic photographs of an object can be made by exposing a photographic film record through a lenticular screen with attendant relative movement between the camera lens, the object, and/or the film to provide a lenticulated or striplike base image, each striplike image being representative of a different viewing angle of the object being photographed. When the resulting exposed base film image is viewed through a lenticular screen having suitable optical characteristics, the picture seen will appear to have depth and will generally have stereoscopic characteristics, regardless of the viewing angle.

In addition to depth, stereoscopic images can be used to convey a fourth dimension, time, as a sequence of images (so-called “Four-Dimensional” (4D) images). For example, a sequence of ten exposures, each separated by a fraction of a second, can be combined to produce a short movie. If during exposure the film is moved on its vertical or horizontal axis so that each of the ten exposures captures a different view of the object, person or scene, a time sequence of events occurring can be viewed from a single formatted, complex image as described in U.S. Pat. No. 3,783,282, (the '282 patent) issued to Reuben Hoppenstein on Jan. 1, 1974 and entitled “Stereoscopic Radiography Techniques and Apparatus,” hereby incorporated by reference as if fully set forth herein. A method and apparatus for stereographic radiography are described in this patent, wherein a conventional xray source is used as a source of radiant energy. In U.S. Pat. No. 5,049,987 (the '987 patent) and U.K. Patent No. 9722146.9, also issued to Reuben Hoppenstein and entitled “Method and Apparatus for Creating Three-Dimensional Television or Other Multi-Dimensional Images, a method of recording a scene and its transinssion was described wherein the viewing of a combined or complex image is achieved by using a lenticular lens in front of a CRT or LCD screen.

In the '987 Patent, hereby incorporated by reference as if fully set forth herein, the techniques of the '282 patent were extended to apply to the fields of Fluoroscopy, Computerized Axial Tomographs, Magnetic Resonance Imaging, Television, Movies and the three dimensional display of other types of visual images.

The techniques described in both the '282 patent and the '987 patents are limited by the required use of a lenticular viewing screen that must be properly aligned with respect to the subject image in order to appreciate the stereoscopic view. Moreover, the use of this screen is time consuming, requires micrometers for adjustment and is generally more expensive.

To address the shortcomings of the prior art, it is an object of the present invention to achieve lensless imaging based on the principles of slit hole/pin hole cameras and thereby provide a novel means to view 3-D/4-D images.

It is a further object of the present invention to expand on the teachings of U.S. Pat. No. 6,061,424 and U.K. Patent No. 9722146.9 issued to Hoppenstein, et al. on May 9, 2000 and Mar. 8, 2000 respectively, the teachings of which are incorporated herein by reference.

### SUMMARY OF THE INVENTION

Accordingly, the present invention provides a novel means and technique for viewing stereoscopic images. Specifically, the lenticular lens viewing screen required in the prior art is replaced with an optical grid forming a virtual lens of thin light transmitting slits that are controlled electronically.

Utilizing the optical principles behind slit-hole cameras, the current invention acts as an array of apertures which allows one eye to see one image while the other sees another angulated view—giving a stereoscopic pair of images, which in turn is combined and interpreted by the brain and perceived as a 3-D image. When the combined image is composed of more than four or five angled views, a person with vision in only one eye can also perceive images in 3-D. This is because the eyes are never perfectly still and vibrate horizontally with minute and rapid movement, and the brain perceives depth by combining and interpreting the pairs of stereoscopic images. This is the reason when a person stares at an object and then closes one eye—the image does not flatten out and become 2-D. It is to be understood that an array of apertures, slits, raster, lined opaque screen, spatial light modulator, diffuser, parallax barrier screen, lattice screen, grating or interference plate, all refer to an optical lens that can create different angulated views for each eye.

In one advantageous embodiment, the virtual viewing lens of the present invention is an electronically controlled Liquid Crystal Diode (“LCD”) viewing lens (“Viewing Lens”) placed in front of a Cathode Ray Tube (“CRT”), LCD Display or similar display (hereinafter “Image Display”). The Viewing Lens is an LCD screen which is transparent in the “off” mode, and by electrically aligning selected Liquid Crystals to their opaque state in the “on” mode, alternating vertical light-transmitting slits and light-absorbing lines covering the screen can be formed. It is to be understood that the Viewing Lens of the present invention can also be implemented with devices other than an LCD screen, as long as alternating light-transmitting slits and light-absorbing lines can be formed. The LCD on the viewing lens and the Image Display are separated by a plate made of light transmitting medium (“Spacer Plate”), made of glass or plastic, and having a predetermined thickness. The Viewing Lens acts as a virtual lenticular screen for images projected on the Image Display. When viewed through the Viewing Lens, the image appears as a 3-D or 4-D image without the use of additional viewing devices.

In another embodiment, the Image Display, Spacer Plate and Viewing Lens are integrated and combined into a sandwich-like construction, which is suitable for use in flat video display screens or advertising displays.

In a third embodiment, the Viewing Lens act as the slit of a slit-hole camera and the image from a point or slit light source is diffracted through the Viewing Lens to form a 3-D or 4-D image on a screen.

In a fourth embodiment, the Viewing Lens is an Electro-Mechanical Lens (“E-M Lens”) constructed primarily of metal. The lens is lined with small metal shutters made of thin metal plates, which are opened and closed by electromechanical means. When the shutters are in the “off” position for regular 2-D image viewing, the shutters are at 90° to the horizontal (i.e., 90° to the Image Display). Because the shutters are constructed of very thin metal plates, they do not obstruct the view when viewed in this position. When the shutters are turned “on” for viewing 3-D or 4-D images, the shutters are rotated 90° to be in line with the Image Display, creating black lines that are slightly separated and forming apertures to allow viewing of different stereo image pairs. The E-M Lens can be placed behind of or in front of the sandwich construction.

In another embodiment the viewing lens of the present invention can be used for viewing a three dimensional image transmitted in fluoroscopy, television, computer, or electronic advertising screen, if the signal was produced with the camera as described in the '987 patent, or by any other means of combining two or more angular views. In this embodiment the viewing lens can be formed on a CRT, LCD display or other electronic screen by turning selected LCD pixels to their opaque state. A television set equipped with an LCD viewing lens can be used to view conventional two-dimensional programs by turning off power to the LCD viewing lens, which would become transparent. In a television, a 3-D image will be created and viewed through use of a separate electronic lens screen image transmitted to a screen in front of or behind the multiplexed image screen and separated by an appropriate transparent spacer.

### BRIEF DESCRIPTION OF THE DRAWINGS

FIG. 1 is a prior art schematic illustration of a prior art optical technique for obtaining a film record containing parallax and providing a visual depth effect;

FIG. 2 is a prior art schematic illustration of a film containing a plurality of discrete images providing depth information, and an overlying lenticular screen so as to enable observation of the film record from virtually any angle, as above discussed;

FIG. 3 is a prior art schematic illustration of a viewing lens having alternating light absorbing lines and light transmitting lines as described in the '424 patent.

FIG. 4 shows a simple slit-hole camera construction enlarging an image of a straight line.

FIG. 5 shows a lenticular lens enlarging the same line, demonstrating the thin slits and narrow transparent spaces between the wider opaque lines acts as lensless lenticular lenses.

FIG. 6 illustrates a “sandwich construction” lens in accordance with the invention which incorporates an Image Display, a transparent spacer, and an electronically controlled viewing lens.

FIG. 7 illustrates a close-up schematic of an electro-mechanical lens showing the opening and closing of the shutters.

FIG. 8 illustrates the electro-mechanical lens in the “off” position for viewing of normal 2-D images.

FIG. 9 illustrates the electro-mechanical lens in the “on” position for viewing of 3-D/4-D images.

### DETAILED DESCRIPTION OF THE INVENTION

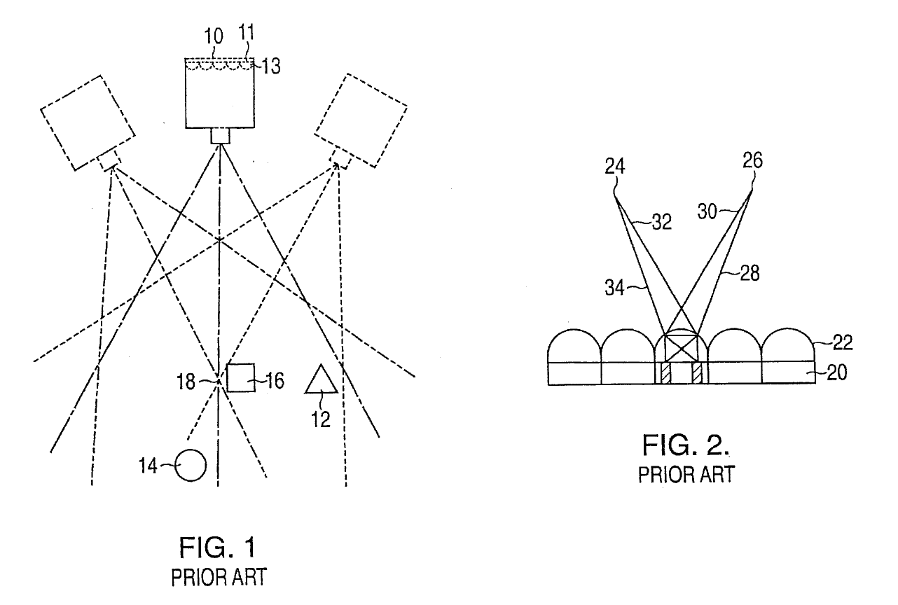

Typical prior art cameras for obtaining stereographic photographs are well known and are schematically indicated in FIG. 1. They generally comprise a standard commercial camera 10 mounted on a suitable non-illustrated structure for traversing a path about one or more subject images 12, 14 and 16, film 11, and an overlying lenticular screen 13. As shown in FIG. 1, camera 10 is capable of being moved between dottedline positions along an arc whose radii intersect at point 18, the central point of any particular picture to be taken. The different relative positions of the camera while photographing the object, or the difference in point of view, i.e., parallax, of the camera as it traverses its arc is illustrated by the rays extending from each of the cameras. The relative rays are designated by dotted lines with respect to the left position of the camera, by solid lines with respect to the central position of the camera, and by dash lines with respect to the right position of the camera. It should therefore be noted that with this arrangement, camera 10 will view the objects 12, 14 and 16 from different points of view as the camera traverses its arcuate path. Lenticular screen 13, positioned between the camera lens and film 11, must be sequentially moved along with movement of camera 10 between the two end points of the arcuate path. By virtue of the refractive and focusing characteristics of the lenticle elements of lenticular screen 13, light received by the camera lens and passing to the screen 13 will be focused onto a given vertical line of film 11 behind each lenticle and, as the screen moves, this vertical line also moves so as to produce the lenticulated image on film 11. The developed film is illustrated at 20 in FIG. 2. What will be stored, then, on the camera film, is a plurality of lenticulated images or strips of the objects 12, 14 and 16, each viewed from a different angle and thus containing what can be termed parallax.

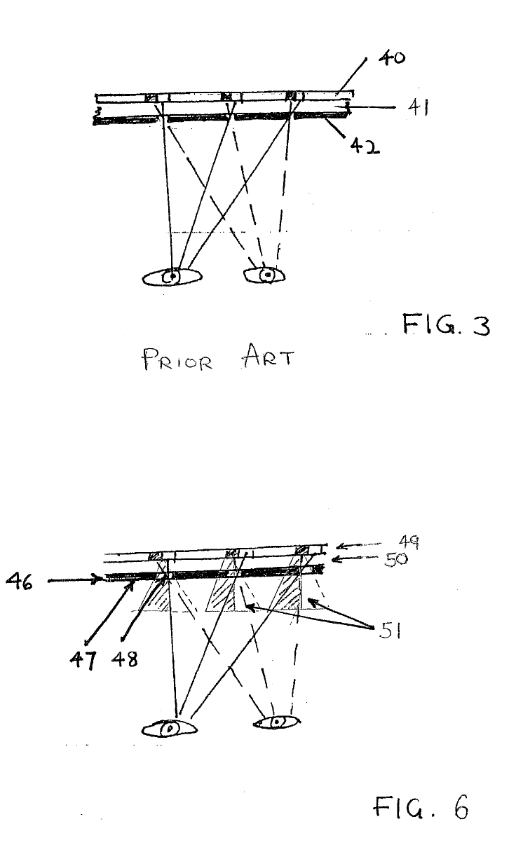

In the prior art, a stereoscopic view of the image could only be seen through a superimposed plurality of lenticles forming a viewing screen 22, similar to screen 11. The invention described in the '424 Patent (See FIG. 3), eliminates the undesirable lenticular viewing screen and replaces it with a viewing lens having alternating light absorbing lines and light transmitting lines.

In one embodiment described in the '424 Patent, a photographic film 40 is made with a transparent layer 41 on one side. The viewing lens 42 is printed directly on the opposite side of the transparent layer 41. Immediately after developing the film the recorded image could be viewed with stereoscopic characteristics without requiring additional devices.

Because display screens vary in size from several inches to several feet (centimeters to meters), utilizing the teachings of the '424 Patent would be difficult, as a different lens would be necessary for each different sized electronic picture, computer or television screen. This would be expensive and cumbersome and would require constant realignment of the lens to the picture.

The present invention provides a novel means and technique for viewing stereoscopic images by replacing the lenticular lens viewing screen required in the prior art with an optical grid which forms a lenseless virtual lens of light transmitting slits that are controlled electronically.

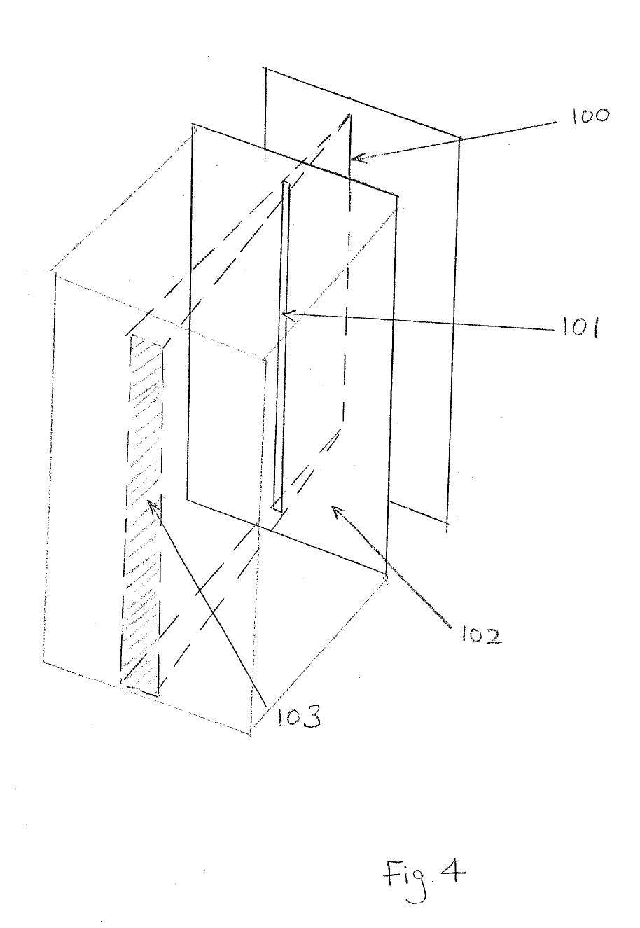

These slits act in a similar manner to the slit of a slit-hole camera. FIG. 4 shows a simple slit-hole camera construction. An image of a straight line 100 passes through a slit-hole 101 in the front of the camera 102. The light passes through the slit-hole and a magnified image 103 is formed. If a light sensitive film is placed in the camera, the image can be recorded. It can be shown that the slit-hole acts as a lenseless lenticular lens. Referring to FIG. 5, by utilizing a light transmitting lenticular lens made of glass or plastic 104, we can see that the same straight line 105 also forms a magnified image 106.

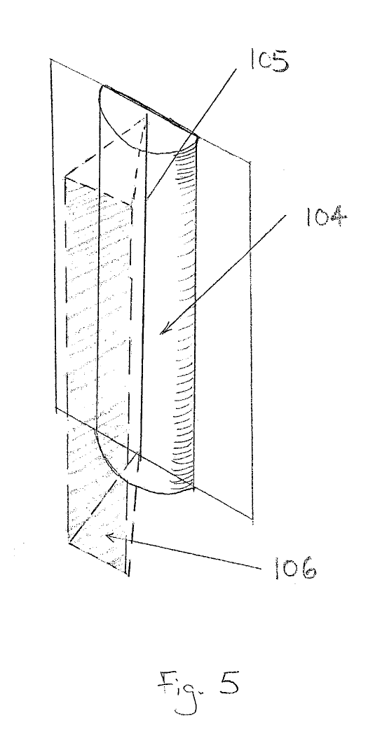

Based on this principle, the present invention utilizes a series of slits, each of which act as a lenseless (virtual) lenticular lens. In one embodiment of the present invention for use on electronic viewing screens as depicted in FIG. 6, a virtual viewing lens is created by biasing an LCD organic crystal screen, diode display screen etc. 46, to form a plurality of vertical opaque lines 47 alternating with vertical light transmitting slits 48 on a screen, placed in front of a display such as a phosphor plate in a CRT or a LCD Image Display 49. The lens and the display screen are separated an appropriate distance by a transparent spacer made of glass or plastic 50. A multiplexed image is projected on the Image display 49 and transmitted through the transparent spacer 50 and viewing lens 46 to a separate attached screen (not shown), placed either in front of or behind the projected virtual image 51. Therefore, the stereoscopic image pairs will be enlarged to the same scale and in alignment on the screen. This obviates constant re-alignment to avoid misaligned images screens on the receiver. For a 2-D image viewing, a signal turns the lens “off” and the viewing lens remains transparent.

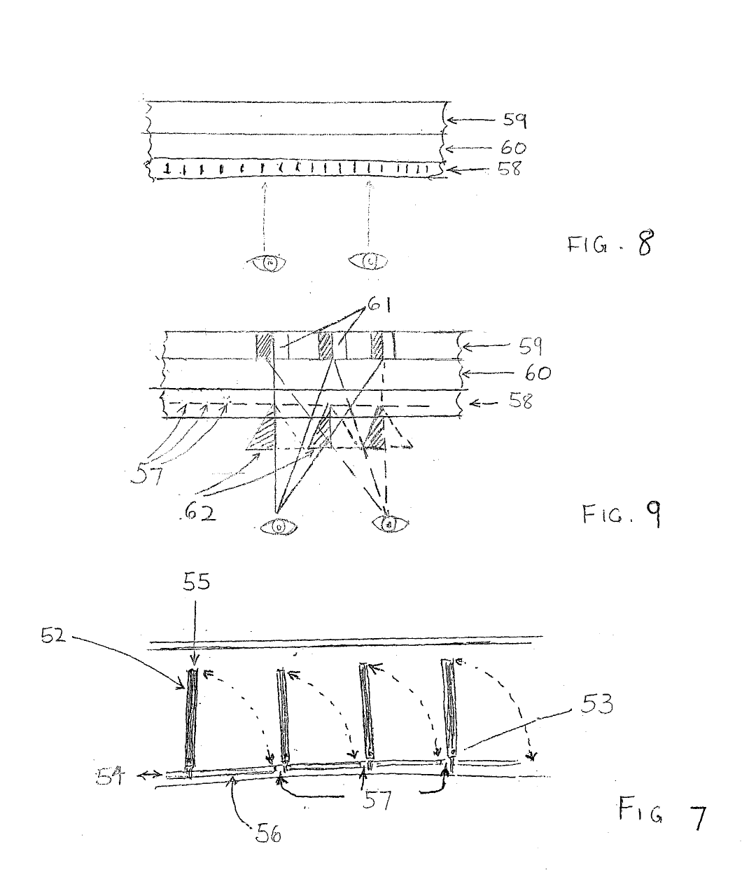

In another embodiment as depicted in FIGS. 7-9, the Virtual Viewing Lens is an electro-mechanical virtual lens constructed primarily of metal 58 placed in front of an Image Display or light source separated by a transparent spacer 60. Very thin metal plates form “Shutters” 52 hinged on pivots 53 which open and close by electro-mechanical means 54. Such means would include electric motor driven rod or link assemblies to open and close the hinged shutters, or the shutters could be electro-magnetically opened and closed with small magnet assemblies at the hinges. As the shutters are constructed of an extremely thin material, they do not obstruct the view for normal 2-d viewing when they are opened to 90° to the horizontal plane 55 (see FIGS. 8). When the shutters are turned parallel to the horizontal plane 56, they create slits 57 which act as lenticular lenses for viewing the multiplexed image 61 projected on the image display 59, and the viewer sees a composite virtual 3-D image 62.

The Image Display, Spacer Plate and Viewing Lens can be integrated and combined into a sandwich-like construction, which is suitable for use in flat video display screens, or for electronic advertising displays used for showing 3-D images in a lightbox. In a computer driven 3-D display, different 3-D images can be changed at regular intervals, again using the multiplexed image on one screen and the grid on another. Both images are transmitted together for viewing, but both should be included on the same frame so that magnification of the 3-D image will be the same from frame-to-frame. This “lens/spacer/multiplexed image” sandwich construction (“L/S/M construction”) can also be used for viewing 3-D or 4-D fluoroscopic images, computerized tomography (C.T. Scans), magnetic resonance scans, PET Scans, ultrasound images or any other electronic displays.

In addition, different image strips from different studies, such as CT and MRI scans can be combined to give 3-D images with Accurate Bony Landmarks for surgeons, and again can be viewed individually or combined on such a L/S/M construction.

The same system can be used and combined with CAD CAM software so that the observer would be able to rotate the 3-D image. This would be an advance for security at airports. A suitcase could be rotated in 3-D revealing hidden objects.

In Fluoroscopy (medical and security), real time observations could be displayed on the GSM Screen by using an X-ray beam that fires sequentially or synchronously from three X-ray beams, as described in U.S. Pat. No. 5,049,987. This would be particularly useful for any catherization, stereotactic surgery or the accurate placement of artificial joints, screws etc. This would minimize the time necessary for the procedure, make operations less hazardous and would be more economical because of the time savings.

Similarly, a viewing lens placed in front of a cathode ray tube (“CRT”) or a viewing lens placed in front of or behind an LCD screen would also enable viewing a stereoscopic transmitted image in three or four dimensions. As explained above, in order for the image to appear to have depth the viewing lens must be spaced from the screen. Any transparent material such as glass or plastic can separate the viewing lens from the screen.

Additional applications for the viewing lens of the present invention include viewing multiple images created by different studies such as computerized axial tomography (CAT), magnetic resonance imaging (MRI), or positron emitting technology (PET). These images or cuts would need to be spaced ¼ degree to ½ degree apart when produced and then combined electronically, digital or analog, as described in the '987 patent.

Indeed, a composite image can also be created from the combination of images taken from different studies. For example, since CAT scans produce bony landmarks and MRI scans produce excellent soft tissue images, the two can be combined on a single three or four dimensional image, giving accurate coordinates for a physician for stereotactic manipulation or surgery. In addition, physiological studies done on PET scans can also be incorporated. For example, two views from a CAT scan giving bony landmarks, four cuts from an MRI showing soft tissue, and if necessary, two cuts from a PET scan showing metabolic activity, can all be combined on one picture, provided of course that the images are of the same size and the correct angles have been recorded. Furthermore, stereoscopic images of diagnostic studies, such as angiograms, movement of a joint, and the beating of a heart, recorded as described in the '987 patent or other like means, can be viewed with the viewing lens of the present invention.

The foregoing merely illustrates the principles of the present invention. Those skilled in the art will be able to devise various modifications, which although not explicitly described or shown herein, embody the principles of the invention and are thus within its spirit and scope.

What is claimed is:

1. An optical system for viewing 3-D or 4-D images on computer screens, televisions, CRTs, LCDs, advertising displays or other displays, comprising: a viewing lens, an image display to display a multiplexed image, and a transparent spacer separating the viewing lens and the image display.

2. The system of claim 1, wherein the viewing lens is an electronic screen with alternating vertical light-transmitting slits and light-absorbing lines when turned on by an electrical signal, and transparent when turned off.

3. The system of claim 1, wherein the viewing lens is an electro-mechanical screen with thin metal shutters that create apertures when turned on by an electrical signal, and unremarkable and unobstructive when turned off.

4. The system of claim 1, wherein the multiplexed image is transmitted as a separate video signal.

5. The system of claim 2 or 3, wherein the lens is turned on and off by a signal transmitted on a video band.

6. The system of claim 1, wherein the multiplexed image and lens are enlarged equally.

7. The system of claim 1, wherein the image signal and lens signal are transmitted by electronic means.

8. The system of claim 2 or 3, wherein the viewing lens is placed in front of the multiplexed image and is separated from it by a transparent spacer.

9. The system of claim 2 or 3, wherein the viewing lens is placed behind the multiplexed image and is separated from it by a transparent spacer.

10. The system of claim 7, wherein the system is incorporated for use in computer screens, televisions, CRTs, LCDs and advertising displays.

11. The system of claim 8, wherein the system uses a computer to generate multiple or single 3-D or 4-D displays in a sequential manner on the same screen.

12. The system of claim 8, wherein the lens is adaptable for attaching to existing computer screens, televisions, CRTs, LCDs, and advertising displays.

13. The system of claims 2 or 3, wherein the viewing lens, the transparent spacer and the image display to display a multiplexed image are integrated and combined into a sandwich-like layered construction.
